(19) United States
(12) Patent Application Publication
(10) Pub. No.: US 2003/0007004 A1
(43) Pub. Date: Jan. 9, 2003

(54) Differentiating dialog box boundaries by implementing reserved colors

(76) Inventors: Rajesh Kanungo, Sunnyvale, CA (US); Eileen L. Bugee, Los Altos, CA (US)

Correspondence Address: MARTINE & PENILLA, LLP, 710 LAKEWAY DRIVE, SUITE 170, SUNNYVALE, CA, 94085, US

(21) Appl. No.: 09/883,008

(22) Filed: Jun. 14, 2001

(51) Int. Cl. G06F 3/00

(52) U.S. Cl. 345/762

(57) ABSTRACT

A method for selecting colors to draw a dialog box having a visually differentiable boundary is provided. The method includes determining whether one of the dialog box boundary, a dialog box background, and a dialog box component is being drawn. The method selects a reserved color to draw the dialog box boundary by bypassing a mapping of the reserved color to a previously assigned cross-platform compatible color. The method selects a cross-platform compatible color when drawing the dialog box background, and selects a cross-platform compatible color when drawing the component contained within the dialog box. Bypassing the mapping of the reserved color to a previously assigned cross-platform compatible color is designed to draw a dialog box having a differentiable boundary.

### BACKGROUND OF THE INVENTION

1. Field of the Invention

The present invention relates generally to computer graphics, and more particularly, to methods for differentiating dialog boxes and/or graphical features from displayed background graphical features.

2. Description of the Related Art

In today's fast paced computing world, more and more computer programmers are predominantly implementing computer graphic interfaces to provide user-application interaction. As graphics-driven applications have replaced command-driven applications, end users have learned to interact through various graphic entities, know as graphical user interfaces (GUIs). Currently, many such applications are implemented using the JAVA programming language due to the simplicity JAVA offers to both the JAVA developers and the end users. JAVA developers enjoy JAVA's broad user base, platform independence, object orientation, reduced development costs, and a consistent execution environment, while the end users benefit from JAVA's live content, just-in-time software, and increased security.

JAVA has achieved a widespread use partly due to its use on the World Wide Web and its success. For example, JAVA has enabled web designers to implement cross-platform compatible web sites with colored, animated, and interactive web pages. However, the use of cross-platform compatible web pages also requires that the web designers choose and implement cross-platform compatible colors in designing web sites and web pages. This is important as out of the 256 or less colors of an industry standard 8-bit color table, only 216 of them are considered cross-platform compatible colors (i.e., colors, which are common between Netscape Navigator, Internet Explorer, and Mosaic, whether on the Macintosh or Windows platforms). As to the remaining 40 colors, they are colors reserved by each operating system for use by that particular operating system only. Consequently, JAVA and other user interface developers often utilize the 216 browser safe colors or cross-platform compatible colors to design web pages.

By way of example, when an end user using an 8-bit display system implements a graphics entity having an 8-bit color value, the 8-bit color value is used as an index to a false color table, thus generating a false index value. Generally, the false color table includes each of the 256 colors of the 8-bit color table such that each of the indexes 0 to 255 of the false color table respectively correspond to colors 1 through 256 of the 8-bit color table. Next, the false index value is used as an index to a color table wherein each of the indexes 0 to 215 of the color table respectively corresponds to each of the cross-platform compatible colors 1 through 216. In a like manner, each of the indexes 216 to 255 of the color table respectively corresponds to each of the reserved colors 217-256 of the 8-bit color table. At this stage, a false index value that corresponds to a cross-platform compatible color index is mapped to its corresponding cross-platform compatible color. However, any false index value that corresponds to a reserved color value is mapped to a previously assigned cross-platform compatible color. Simply stated, when the end user has selected a cross-platform compatible color, that cross-platform compatible color is ultimately displayed. However, if the end user has chosen one of the reserved colors, the underlying software or the residing operating system detects and corrects such error by mapping the selected reserved color to a previously determined cross-platform compatible color or by dithering the color.

As evident, an end-user, a web designer, or a JAVA developer is free to implement any of the 216 cross-platform compatible colors of the 6×6×6 cube to draw web page backgrounds, dialog box borders, and dialog box backgrounds. However, this freedom to choose any of the 216 cross-platform compatible colors has created a great deal of confusion.

For instance, drawing dialog boxes using the same range of 216 cross-platform compatible colors implemented to draw the web pages and their displayed backgrounds is confusing. In one scenario, this creates a great deal of uncertainty where the dialog box background is drawn in relation to the same color that might be used to display background elements. The extent of users' confusion is magnified in situations where user-input data is required; however, the user is unable to ascertain the location of the input field. In particular, where modal dialog boxes (i.e., dialog boxes that allow the user to only work inside the dialog box) are used, the frustrated user cannot continue interacting with the application, as the user neither can ascertain the location of the input field nor can the user disable the modal dialog box to continue working.

In a different scenario, a great deal of uncertainty is created when dialog box borders are drawn in the same color as the displayed background which includes multiple input fields. In such situations, as a result of the dialog box borders being in the same color as the web page displayed background, the user cannot ascertain that a new dialog box has been created. Consequently, the user cannot realize that portions of the displayed background are hidden by the new dialog box. As a result, the user fails to input the data required in all the input fields, thus preventing the user from further interaction with the application.

In view of the foregoing, there is a need for a fast and cost effective method to visually differentiate dialog boxes from the displayed background.

### SUMMARY OF THE INVENTION

Broadly speaking, the present invention fills these needs by implementing reserved colors to draw dialog box boundaries, thus visually differentiating the dialog boxes from the displayed background colors. Boundaries are herein defined as any graphical entity that may be considered as a differentiating factor between dialog boxes and the displayed background (e.g., borders, sliders, buttons, scroll bars, text, etc.). Preferably, in one example, dialog box boundaries are implemented through indexing each of the possible reserved color values to its corresponding color value contained within a color table. It should be appreciated that the present invention can be implemented in numerous ways, including as a process, an apparatus, a system, a device, or a method. Several inventive embodiments of the present invention are described below.

In one embodiment, a method for creating a dialog box visually differentiable from a displayed background is disclosed. The disclosed method includes receiving a command to create the dialog box, drawing a dialog box boundary using a reserved color, and drawing a dialog box background using the selected background color value. The command is designed to include a selected background color that has a value. The reserved color is a color reserved by an operating system of a platform to be used by the operating system only. Using of the reserved color to draw the dialog box boundary is designed to visually differentiate the dialog box from the displayed background.

In another embodiment, a method for selecting colors to draw a dialog box having a visually differentiable boundary is disclosed. The disclosed method includes determining whether one of the dialog box boundary, a dialog box background, and a dialog box component is being drawn. The method selects a reserved color when drawing the dialog box boundary by bypassing a mapping of the reserved color to a previously assigned cross-platform compatible color. The method selects a cross-platform compatible color when drawing the dialog box background, and selects a cross-platform compatible color when drawing the component contained within the dialog box. Bypassing the mapping of the reserved color to a previously assigned cross-platform compatible color is designed to draw a dialog box having a differentiable boundary.

In yet another embodiment, a method for generating dialog box graphical user interfaces (GUIs) that are presented over an underlying background image is disclosed. The method includes receiving a command to generate a dialog box. When generating a boundary element of the dialog box, the method also includes implementing a reserved color for the generation. The reserved color is designed not to be available for use in generating graphical context of background color of the dialog box.

The advantages of the present invention are numerous. Most notably, the present invention implements reserved colors to draw dialog box boundaries, thus creating a pronounced visual differentiation between the dialog box boundaries and the displayed backgrounds. In this manner, a feature of the present invention enables the bypassing of an indexing operation implemented in creating cross-platform compatible colors, thus providing a more efficient, easy to use and more cost-effective method.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a block diagram of a process of displaying a pixel containing an 8-bit color value, in accordance with one embodiment of the present invention.

FIG. 2 illustrates a dialog box as created within a frame, in accordance with another embodiment of the present invention.

FIG. 3 illustrates the use of reserved colors in visually differentiating a dialog box background from a displayed background, in accordance with yet another embodiment of the present invention.

FIG. 4A is a flow chart diagram of the method operations performed in creating dialog boxes having boundaries differentiable from the displayed background, according to yet another embodiment of the present invention.

FIG. 4B depicts an instance and inheritance diagram of a dialog peer class in a JAVA based system, in accordance with still another embodiment of the present invention.

FIG. 4C-1 shows a flow chart diagram of the method operations performed during executing the JAVA code to create a dialog box having boundaries that are differentiated from the displayed background, according to still another embodiment of the present invention.

FIG. 4C-2 is a flow chart showing the method operations used in implementing the reserved colors, in accordance to yet another embodiment of the present invention.

FIG. 4C-3 is a flow chart diagram illustrating the method operations to display a selected dialog box background color, in accordance to yet another embodiment of the present invention.

### DETAILED DESCRIPTION OF THE PREFERRED EMBODIMENTS

An invention for visually differentiating between dialog boxes and displayed backgrounds in a computer environment is disclosed. The present invention implements reserved colors to draw the dialog box boundaries. In one embodiment, the reserved colors are operating system dependent reserved colors which are interchangeably referred to as the system colors or reserved colors. Preferably, in one example, the reserved colors are implemented through indexing any of the possible reserved color values to its respective corresponding color value contained within a color table.

In one embodiment, the dialog box boundaries are configured to be beveled. In another implementation, lighter reserved colors are implemented to draw the upper and the left portions of the boundaries while darker reserved colors are used to draw the right and the bottom portions of the boundaries, thus creating a more pronounced visual differentiation. In another example, the boundaries are drawn using multiple reserved colors, thus magnifying the visual differentiation. As a result of the present invention implementing only the reserved colors to draw the dialog box boundaries, user interface developers are prevented from using the cross-platform compatible colors to draw the dialog box boundaries.

As embodiments of the present invention preferably implement the JAVA programming language, an overview of JAVA is provided below. In operation, a user of a typical JAVA based system interacts with an application layer of a system generally written by a third party developer. The application layer generally provides the user interface for the system. A JAVA module is used to process commands received by the application layer. A JAVA virtual machine is used as an interpreter to provide portability to JAVA applications. In general, developers design JAVA applications as hardware independent software modules, which are executed JAVA virtual machines. The JAVA virtual machine layer is developed to operate in conjunction with the native operating system of a particular hardware, which represents the physical hardware on which the system operates or runs. In this manner, JAVA applications can be ported from one hardware device to another without requiring updating of the application code.

Unlike most programming languages, in which a program is compiled into machine-dependent, executable program code, JAVA classes are compiled into machine independent byte code class files which are executed by a machine-dependent virtual machine. The virtual machine provides a level of abstraction between the machine independence of the byte code classes and the machine-dependent instruction set of the underlying computer hardware. A class loader is responsible for loading the byte code class files as needed, and an interpreter or just-in-time compiler provides for the transformation of byte codes into machine code.

More specifically, JAVA is a programming language designed to generate applications that can run on all hardware platforms, small, medium and large, without modification. Developed by Sun, JAVA has been promoted and geared heavily for the Web, both for public Web sites and intranets. Generally, JAVA programs can be called from within HTML documents or launched standalone. When a JAVA program runs from a Web page, it is called a “JAVA applet,” and when run on a Web server, the application is called a “servlet.”

JAVA is an interpreted language. The source code of a JAVA program is compiled into an intermediate language called “byte code”. The byte code is then converted (interpreted) into machine code at runtime. Upon finding a JAVA applet, the Web browser invokes a JAVA interpreter (JAVA Virtual Machine), which translates the byte code into machine code and runs it. Thus, JAVA programs are not dependent on any specific hardware and will run in any computer with the JAVA Virtual Machine software. On the server side, JAVA programs can also be compiled into machine language for faster performance. However a compiled JAVA program loses hardware independence as a result.

Keeping this brief introduction to JAVA in mind, reference is now made to a block diagram 100 of FIG. 1, in accordance with one embodiment of the present invention. FIG. 1 depicts the displaying of a pixel 102 having an 8-bit color value configured to be equivalent to an index 104(218) of a color table 104. As shown, the 8-bit color value of the pixel 102 is indexed to a corresponding color value C218 contained within the index 104(218) of the color table 104. Subsequent to this indexing, the color value C218 is sent out to a controller 106 wherein the color value C218 is processed. In one embodiment, the controller 106 is a graphics card which processes the color value C218 by converting the data within the computer system's memory into signals that are used to refresh a display screen component of the display system 108.

As illustrated, the color table 104 is a color palette in the form of an array having 256 array elements indexed as 104(0) to 104(255). Each of the indexed array elements 104(0) to 104(255) is designed to contain a respective predefined color value C0 through C255. In one embodiment, the 256 color values C0 through C255 are the predefined red, green and blue (RGB) values and are supported by an industry standard 8-bit color table. As designed, the color values C0 through C215 respectively indexed as elements 104(0) to 104(215) are configured to be the cross-platform compatible colors 104A. In a like manner, the color values C216 through C255 respectively indexed as elements 104(216) to 104(255) are configured to be the reserved colors 104B.

As shown, despite the 8-bit color value of the pixel 102 pointing to a color value C218, the present invention has the capability to process and display the color value C218 which in fact is a reserved color. Therefore, advantageously, the present invention provides an opportunity to map the 8-bit color values of each and every pixel or image to its corresponding RGB color value as contained within the color table 104 irrespective of the fact that the 8-bit color value may be indexed to one of the reserved colors C216 to C255.

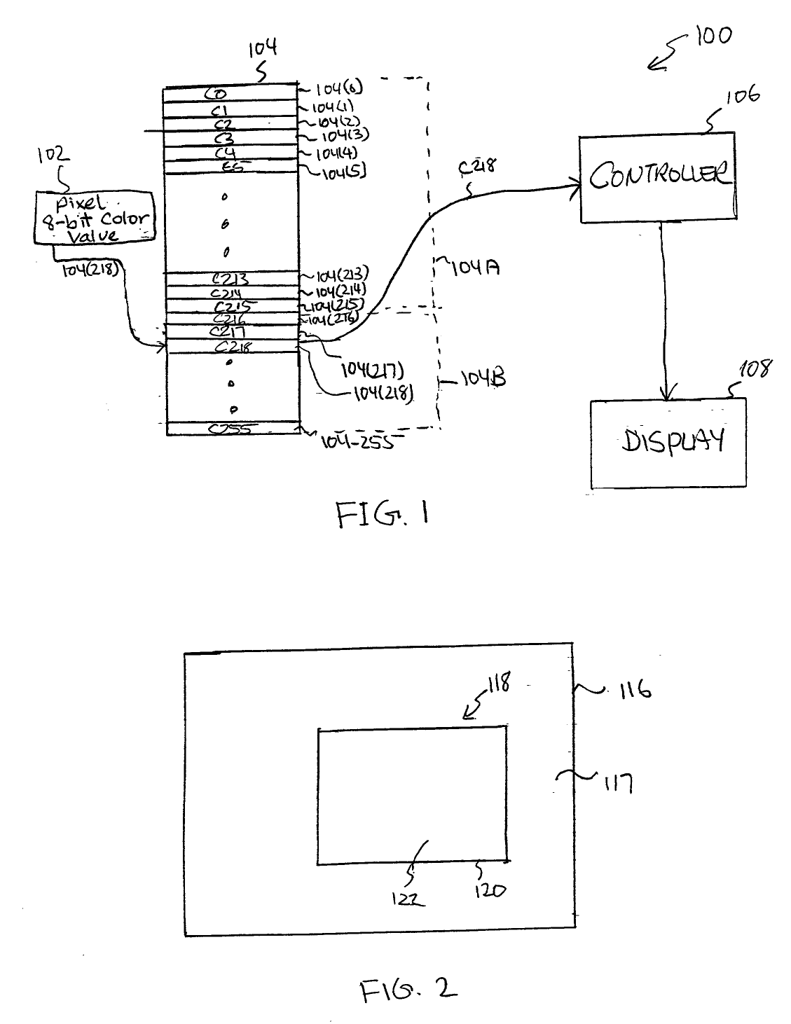

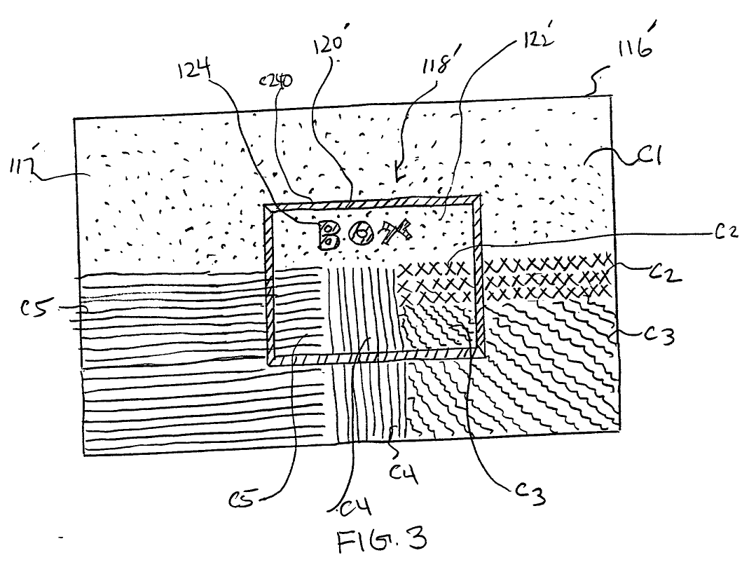

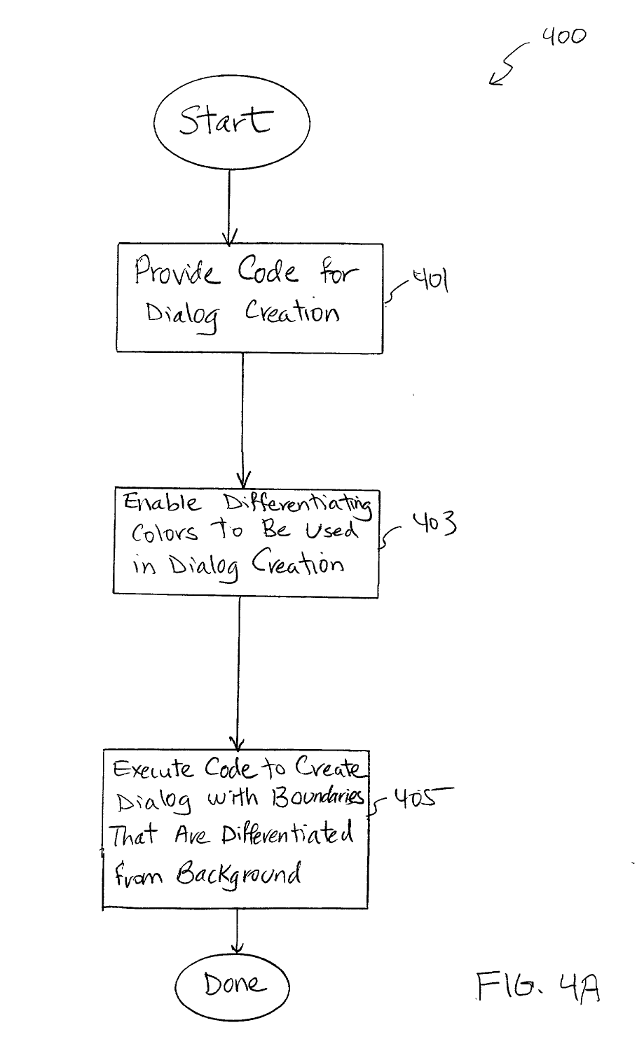

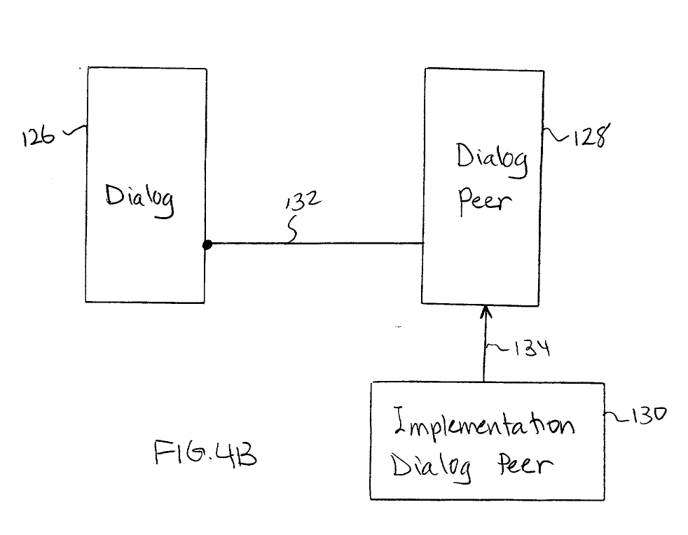

Reference is now made to FIG. 2 illustrating a dialog box 118 created within a frame 116, in accordance with one embodiment of the present invention. As discussed in more detail with respect to FIG. 1, a displayed background 117 of the frame 116 and a dialog box background 122 of the dialog box 118 may be selected from any of the 216 cross-platform compatible colors. However, boundaries 120 of the dialog box 118 of the present invention are configured to be drawn implementing one of about approximately 40 reserved colors. As illustrated in the embodiment of FIG. 3, dialog box boundaries 120′ are drawn implementing a reserved color C240 which beneficially differentiate between a displayed background 117′ of a frame 116′ and a dialog box background 122′ of a dialog box 118′.

As depicted in the illustrated example, the corresponding portions of the dialog box background 122′ and the displayed background 117′ are drawn from colors C1, C2, C3, C4, and C5. However, as a result of the boundaries 120′ of the dialog box 118′ being drawn from a reserved color C240, an end-user can visually differentiate between the displayed background 117′ and the dialog box background 122′. In one preferred embodiment, the visual discrimination between the displayed background 117′ and the dialog box background 122′ can be more pronounced through creating the boundaries 120′ such that they are beveled. Furthermore, in one example, lighter reserved colors may be implemented to draw the upper and the left portions of the boundaries 120′ while darker reserved colors are used to draw the right and the bottom portions of the boundaries 120′. Additionally, in another implementation, the boundaries 120′ may be drawn implementing multiple reserved colors, thus magnifying the visual differentiation between the displayed background 117′ and the dialog box background 122′.

As the boundaries 120′ are configured to be any graphical entity that may be considered as a differentiating factor between the dialog boxes and the displayed backgrounds, one must appreciate that the reserved colors may be used to draw all of such differentiating factors. For instance, the example of FIG. 3 is configured to include border-type boundaries 120′ and a text string-type boundary 124 defined within the dialog box 118′, in close proximity of the border-type boundaries 120′. When the boundaries 120′ are configured to include both border-type boundaries and text-type boundaries, the reserved color C240 can be implemented in drawing both the text string 124 and the border-type boundaries 120′. Thus, in the embodiments of the present invention, any of the reserved colors may be used to draw any of the differentiating factors between the dialog box 118′ and the displayed background 117′ (e.g., borders, sliders, buttons, scroll bars, text, etc.).

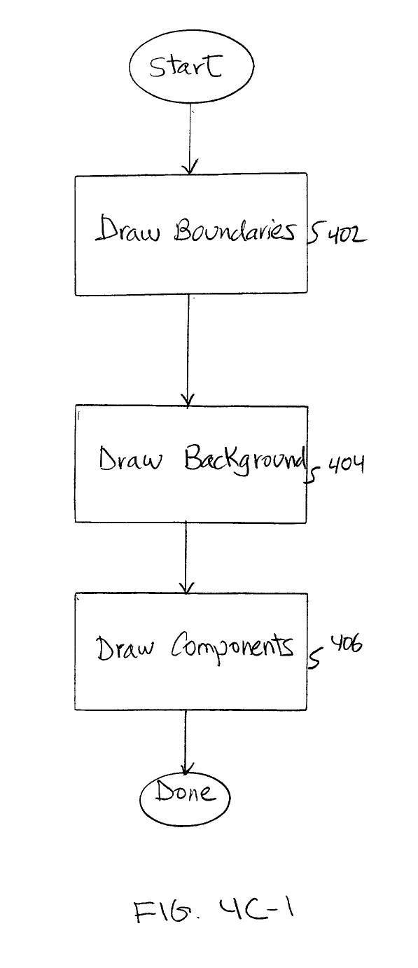

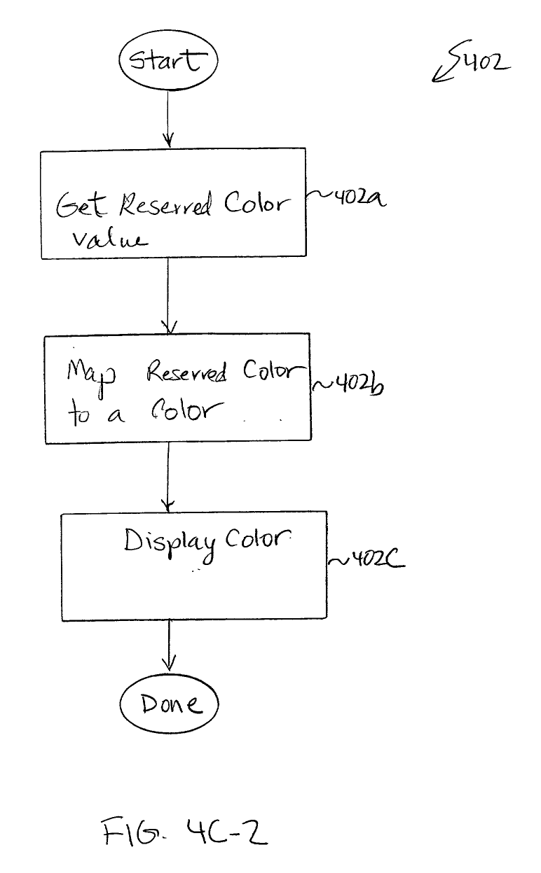

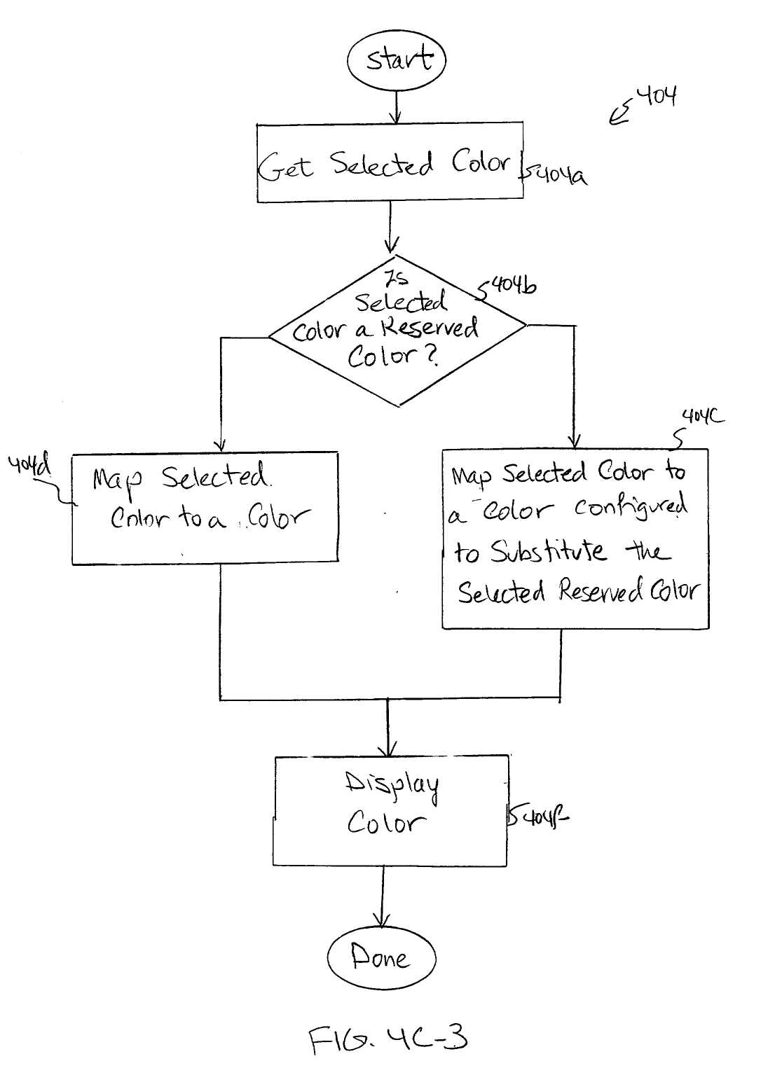

The embodiments of the present invention can further be understood with respect to FIG. 4A showing a flow chart diagram 400 of the method operations performed in creating dialog boxes having boundaries differentiable from the displayed background, according to one embodiment of the present invention. The method begins in operation 401 wherein a programming code to create a dialog box is provided. As shown below in Table 1, preferably, in a JAVA based system, a JAVA method is implemented to create the dialog box. For instance, in one implementation, a dialog box is created by calling a “Dialog” method and providing data to a plurality of variables “frame,” “parent,” “string title,” and “boolean modal” of the Dialog method. Subsequently, a “drawborder” method having two input variables “reserved_color_map” and “reserved_color_index” is called which is then followed by a call to the clip & draw background method having an input variable standard_color. As shown, while the drawborder method implements a reserved_color to draw the boundaries of the dialog box, the clip & draw background method implements a standard_color (i.e., one of the cross-platform compatible colors) to draw the background of the dialog box.

TABLE 1
JAVA Programming Code for Dialog Box Creation
JAVA Code

Dialog (frame, parent, string title, boolean modal) {
draw border (reserved_color_map, reserved_color_index);
clip & draw background (standard_color);
clip & draw components;
}

Next in operation 403, the method enables the use of differentiating colors in dialog box creation. As will be discussed in more detail in reference to FIG. 4B, the present invention enables the use of differentiating colors by implementing a dialog, a platform independent dialog peer, and a platform dependent implementation dialog peer class. The implementation dialog peer class is configured to draw the dialog box boundaries using only colors reserved to be used by the operating system of that specific platform. The method then continues to operation 405 in which the programming code to create dialog boxes with boundaries that are differentiated from background is executed. Specifically, in one embodiment, in drawing the dialog box boundaries, an 8-bit reserved color value of each pixel is indexed to a corresponding color value contained in the color table. In contrast, only one of the cross-platform compatible colors 1 to 215 may be used to draw the dialog box backgrounds and the components contained therein. In a situation where a reserved color has been selected to draw the dialog box background or the contained components, the selected reserved color is indexed to a previously assigned cross-platform compatible color. More details regarding executing the code to create differentiating dialog box boundaries are set forth below in reference to FIGS. 4C-1 to 4C-2.

FIG. 4B depicts the instance and inheritance diagrams of a dialog peer class 128 (i.e., java.awt.peer.Dialog Peer) in a JAVA based system, in accordance with one embodiment of the present invention. As shown, a dialog object 126 is an instance of the class dialog peer 128 while a class implementation dialog peer 130 is a class designed to inherit from the dialog peer 128. The dialog object 126 includes a pointer peer 132 to the dialog peer 128. The pointer peer 132 is configured to point each dialog code to its corresponding dialog peer code. The dialog peer 128 is an abstract class configured to create a template for the dialog object 126.

As an abstract class, the dialog peer 128 is configured to be platform independent. That is, the dialog peer 128 is configured to include almost all of the characteristics common to substantially all of the window-based systems or other systems (e.g., Windows, X-windows, Macintosh System 7, etc.). In contrast, the implementation dialog peer class 130 is configured to be platform dependent and is designed to inherit and execute almost all of the methods of dialog peer 128. Furthermore, the implementation dialog peer 130 is configured to include additional methods designed to interact with the underlying system.

For instance, as shown below in Table 2, in dialog code, a new Windows-X-type dialog box “d” can be created through a “new” method call, and subsequently shown through a “d.show” method call. However, due to dialog object 126 being an instance of the class dialog peer 128, the “d.show” method call has a pointer to a “peer.show” method call in the dialog peer 128. In turn, the “peer.show” method call of the platform independent dialog peer 128 is executed by the implementation dialog peer 130, using the code shown in Table 3.

TABLE 2
Dialog Code
JAVA Code

Dialog d = new Dialog (X-Windows);
set size;
d.show(X-Windows);

As illustrated below in Table 3, the implementation dialog peer 130 implements a native method “drawborders” to draw the dialog box boundaries using only the system colors. In this manner, the dialog box boundaries are drawn using the system colors, thus ensuring a visual differentiation between the dialog box boundaries in comparison to the displayed background. As shown, the drawborders, draw background, and draw any components contained within the background method calls are configured to be native method calls wherein the underlying system is preferably JAVA based. However, in other systems, the method calls may be implemented such that they are not native methods.

It must be noted that although in this example a new X-windows dialog box has been created, those having ordinary skill in the art should appreciate that the new method call may be implemented to draw a dialog box using the underlying system primitives or any other type of system primitives (e.g., Windows, etc.). Additional details regarding drawing the dialog box boundaries implementing the system colors are set forth below in connection with the descriptions of FIGS. 4C-1 to 4C-3.

TABLE 3
Implementation Dialog Peer Code
JAVA Code

native drawborders with system colors;
native draw background;
native draw any components contained within the background;

Reference is now made to FIG. 4C-1 showing a flow chart diagram of the method operations performed during executing the JAVA code to create a dialog box having boundaries that are differentiated from the displayed background, according to one embodiment of the present invention. As illustrated, the method begins with operation 402 in which dialog box boundaries are drawn. As will be discussed below, the dialog box boundaries are drawn using one of the reserved colors, thus visually differentiating between the dialog box boundaries and the displayed background. Additional details regarding drawing the dialog box boundaries implementing reserved colors are set forth below in connection with the description of FIG. 4C-2.

Next, in operation 404 the dialog box background is drawn followed by drawing the other components contained within the dialog box background in operation 406. Further details with respect to drawing the dialog box backgrounds are set forth below with the description of FIG. 4C-3. As will be discussed fully in reference to FIGS. 4C-2 to 4C-3, while only the reserved colors are implemented to draw the dialog box boundaries, only the cross-platform compatible colors are used to draw the dialog box backgrounds and the components contained therein.

Implementing the reserved colors to draw the dialog box boundaries can further be understood with respect to the Table 4 shown below, and flow chart 402 depicted in FIG. 4C-2, in accordance to one embodiment of the present invention. As shown, the method begins in operation 402a in which a reserved color value is provided. Next, in operation 402b the reserved color value is mapped to a color value, which is subsequently displayed in the following operation 402c. As fully discussed above in reference to FIG. 1, the reserved colors can only be used by the operating systems and are thus designed to be operating system dependent. In this manner, the embodiments of the present invention ensure a pronounced visual differentiation between dialog box boundaries and the displayed backgrounds.

TABLE 4
JAVA Programming Code for Implementing Reserved Colors
JAVA Code

SystemDrawColor (8_bit_reserve_color);
int Color = ColorTable[8_bit_reserve_color];
display (Color)

FIG. 4C-3 is a flow chart diagram 404 illustrating the method operations to display a selected dialog box background color, in accordance to one embodiment of the present invention. The method begins at operation 404a wherein a selected color to draw the dialog box background is provided. In one preferred embodiment, the selected color is in the form of an 8-bit color value configured to be equivalent to an index of a color table. Next, in operation 404b a determination is made as to whether the selected color is one of the reserved colors. If a determination is made that the selected color is one of the reserved colors, the method continues to operation 404c wherein the selected color is mapped to a color configured to substitute the selected reserved color. Thereafter, the method continues to operation 404f in which the color is displaced. However, if in operation 404b a decision is made that the selected color is not a reserved color, the method continues to operation 404d in which the selected color is mapped to the corresponding color which is subsequently displayed in operation 404f.

By way of example, the JAVA code to implement a cross-platform compatible color has been provided below in Table 5. As shown, an 8_bit_color_value is used as an index to a FalseColorTable. As shown, the FalseColorTable is in the form of an array having array elements 0 to 255, each of which contains a FalseColorIndex. Thereafter, the FalseColorIndex is used as an index into a ColorTable also designed in the form of an array having elements 0 to 255. As designed, if the 8_bit_color_value is a reserved color, the FalseColorIndex contains an 8-bit value index into a previously assigned array element in the ColorTable. As designed, the previously assigned array element is configured to be one of the cross-platform compatible colors. However, if the 8_bit_color_value is a cross-platform compatible color, the FalseColorIndex contains an 8-bit index into an array element in the ColorTable. This array element is configured to contain the corresponding cross-platform compatible Color.

TABLE 5
JAVA Programming Code for Implementing
Cross-Platform Compatible colors
JAVA Code

int FalseColorIndex = FalseColorTable[8_bit_color_value];
int Color = ColorTable[FalseColorIndex];
display (Color);

Thus, in accordance to the embodiments of the present invention, the dialog box boundaries are drawn using the reserved colors, eliminating the necessity to index a user selected reserved color to a previously assigned cross-platform compatible color. In this manner, the present invention can provide dialog box boundaries that are differentiated from the displayed backgrounds at no cost and faster. Furthermore, one of ordinary skill in the art must appreciate that the components contained within the dialog box boundaries are drawn through implementing substantially the same methods used in drawing the dialog box backgrounds.

In a different implementation, the present invention may define the reserved colors to be a selected set of RGB values. In this embodiment, the reserved colors are neither any of the cross-platform compatible colors nor are any of the approximately 40 operating system reserved colors. Particularly, this example uses approximately about 215 safe colors, approximately about 40 system reserved colors, and a plurality of reserved colors specifically chosen for drawing the dialog box boundaries. For instance, specific indexes of the color table are filled with RGB values specifically chosen to be implemented as reserved colors. An exemplary User Interface Specification to create dialog box boundaries implementing this embodiment is provided below in Table 6.

TABLE 6
Specification for Implementing Reserved Colors
8-bit color specifications [with expanded 8-bit color table]

**x, y coordinates: 0, 0 top left corner of outside bevel.**
Dialog box LEFT and TOP Bevels:
thickness = 7 pixels
outer 4 pixels' color = RGB 197.248.249 [Index 229]
inner 3 pixels' color = RGB 107.174.211 [Index 221]
Dialog box RIGHT and BOTTOM Bevels:
thickness = 7 pixels
outer 4 pixels' color = RGB 0.26.47 [Index 225]
inner 3 pixels' color = RGB 51.74.87 [Index 224]
Dialog box FACE PANEL:
color = RGB 80.134.164 [Index 222]
“Default” Dialog box dimensions, INCLUDING bevels:
Maximum size = 500 pixels wide × 340 pixels high
Minimum size = 400 pixels wide × 100 pixels high
“Default” Title specs:
Text alignment = centered horizontally
If title is longer than the width of the dialog box, the text shall begin
at a “0” point which is 10 pixels from the left edge of the dialog panel
face [x coordinate 17, which includes outer bevels].
Baseline of text = y coordinate 40.
Default Font size = DFL_XLARGE_B [20 pt Helv Reg]
Default Font color = RGB 197.248.249 [Index 229]
“Default” Title ″Beadline″ specs:
total thickness/height = 6 pixels
top 3 pixels' color = RGB 0.26.47 [Index 220]
alignment = centered horizontally
Baseline of beadline = y coordinate 54
Beadline length = x coordinate 57. Beadline should end at a point which is
50 pixels from the right edge of the dialog panel face [excluding
outer bevels.]
Text input field specs:
LEFT and TOP Bevels:
thickness = 4 pixels
color = RGB 0.26.47 [Index 225]
RIGHT and BOTTOM Bevels:
thickness = 4 pixels
color = RGB 165.210.236 [Index 220]
Input area FLOOR:
Color = RGB 36.102.126 [Index 226]

Although the present invention is described based on the JAVA programming language, other programming languages may be used to implement the embodiments of the present invention (e.g., C, C++, any object oriented programming language, etc.). Furthermore, although the present invention is described in the context of 8-bit graphics, one of ordinary skill in the art must appreciate that other graphics may be used to implement the embodiments of the present invention (e.g., 16-bit graphics, 24-bit graphics, 32-bit graphics, etc.). Additionally, one having ordinary skill in the art must bear in mind that the dialog boxes may be displayed implementing any graphic image (e.g., Joint Photographic Experts Group (JPEG), Portable Network Graphics (PNG), Bit MaP (BMP), PCX, any non-vector component graphic image, etc.).

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for creating a dialog box visually differentiable from a displayed background, the method comprising:
receiving a command to create the dialog box, the command including a selected background color of the dialog box configured to have a value;
drawing a dialog box boundary using a reserved color associated with a reserved color value, the reserved color being a color reserved by an operating system of a platform to be used by the operating system only; and
drawing a dialog box background using the value of the selected background color,
wherein using the reserved color to draw the dialog box boundary is configured to visually differentiate the dialog box from the displayed background.

2. A method for creating a dialog box visually differentiable from a displayed background as recited in claim 1, wherein drawing a dialog box background using the selected background color value includes:
determining whether the value for the selected background color is equivalent to one of the reserved color value and a cross-platform compatible color value, the determining including,
mapping the value of the selected background color to a previously assigned cross-platform compatible color value when the selected background color value is equivalent to the reserved color value; and
mapping the value of the selected background color to a corresponding cross-platform compatible color value when the selected background color value is equivalent to the cross-platform compatible color value.

3. A method for creating a dialog box visually differentiable from a displayed background as recited in claim 1, wherein the dialog box is displayed using a graphic image.

4. A method for creating a dialog box visually differentiable from a displayed background as recited in claim 1, wherein the dialog box boundary is configured to include one of a slider, a border, text, a button, and a scroll bar.

5. A method for creating a dialog box visually differentiable from a displayed background as recited in claim 4, wherein the dialog box boundary is a border.

6. A method for creating a dialog box visually differentiable from a displayed background as recited in claim 5, wherein the border is beveled.

7. A method for creating a dialog box visually differentiable a displayed background on a display system as recited in claim 1, wherein the dialog box is a Java-based dialog box.

8. A method for selecting colors to draw a dialog box having a visually differentiable boundary, the method comprising:
determining whether one of a dialog box boundary, a dialog box background, and a dialog box component is being drawn, the determining including,
selecting a reserved color when drawing the dialog box boundary by bypassing a mapping of the reserved color to a previously assigned cross-platform compatible color;
selecting a cross-platform compatible color when drawing the dialog box background; and
selecting a cross-platform compatible color when drawing the component contained within the dialog box,
wherein the bypassing the mapping of the reserved color to a previously assigned cross-platform compatible color is configured to draw a dialog box having a differentiable boundary.

9. A method for selecting colors to draw a dialog box having a visually differentiable boundary as recited in claim 8, wherein the reserved color is a color reserved by an operating system of a platform to only be used by one of the operating system and underlying software.

10. A method for selecting colors to draw a dialog box having a visually differentiable boundary as recited in claim 8, wherein selecting a cross-platform compatible color when drawing the dialog box background includes:
using a value of the selected background color to map the selected background to a previously assigned cross-platform compatible color when the value of the selected background color is equivalent to a reserved color value; and
using the value of the selected background color to map the selected background color value to a corresponding cross-platform compatible color when the value of the selected background color is equivalent to a cross-platform compatible color value.

11. A method for selecting colors to draw a dialog box having a visually differentiable boundary as recited in claim 8, wherein the dialog box is one of a JAVA-based dialog box, a C-based dialog box, and a C++-based dialog box.

12. A method for selecting colors to draw a dialog box having a visually differentiable boundary as recited in claim 8, wherein the dialog box is displayed using a graphic image.

13. A method for selecting colors to draw a dialog box having a visually differentiable boundary as recited in claim 8, wherein the colors selected to draw the dialog box boundary, dialog box background, and components contained within the dialog box are processed by a controller.

14. A method for selecting colors to draw a dialog box having a visually differentiable boundary as recited in claim 13, wherein the controller is integrated in a graphics card.

15. A method for generating dialog box graphical user interfaces (GUIs) that are presented over an underlying background image, comprising:
receiving a command to generate a dialog box;
if a boundary element of the dialog box is to be generated, the method includes,
implementing a reserved color for the generation, the reserved color not being available for use in generating graphical context of background color of the dialog box.

16. A method for generating dialog box graphical user interfaces (GUIs) that are presented over an underlying background image as recited in claim 15, further comprising:
if a background element of the dialog box is to be generated, the method includes,
implementing a cross-platform compatible color for the generation.

17. A method for generating dialog box graphical user interfaces (GUIs) that are presented over an underlying background image as recited in claim 15, wherein the boundary element is configured to include one of a slider, a border, text, a button, and a scroll bar.

18. A method for generating dialog box graphical user interfaces (GUIs) that are presented over an underlying background image as recited in claim 17, wherein the boundary element is a border.

19. A method for generating dialog box graphical user interfaces (GUIs) that are presented over an underlying background image as recited in claim 18, wherein the border is beveled.

20. A method for generating dialog box graphical user interfaces (GUIs) that are presented over an underlying background image as recited in claim 15, wherein the dialog box is one of a JAVA-based dialog box, a C-based dialog box, and a C++-based dialog box.
